(19) United States
(12) Patent Application Publication
(10) Pub. No.: US 2026/0238520 A1
(43) Pub. Date: Aug. 13, 2026

(54) CHANNEL PREDICTION TO COMBAT CHANNEL-AGING WITH LOW COMPLEXITY

(71) Applicant: NEC Corporation, Tokyo (JP)

(72) Inventors: Prakash CHAKI, Tokyo (JP); Jun SHIKIDA, Tokyo (JP); Kazushi MURAOKA, Tokyo (JP)

(73) Assignee: NEC Corporation, Tokyo (JP)

(21) Appl. No.: 19/471,711

(22) PCT Filed: Apr. 11, 2023
(86) PCT No.: PCT/JP2023/014775

§ 371 Date: Oct. 2, 2025

(51) Int. Cl. H04L 25/02

(52) U.S. Cl. CPC H04L 25/0224

(57) ABSTRACT

A communication device includes: a wireless transceiver configured to communicate with another communication device through a wireless channel; and at least one processor configured to execute instructions to: a) estimate at least two channel response matrices of the wireless channel based on a predetermined signal received from the another communication device; b) obtain at least two first eigenvectors or singular vectors of the channel response matrices; and c) predict at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

### TECHNICAL FIELD

The present invention relates to techniques for combatting the effect of channel aging in a wireless communication channel.

### BACKGROUND

A typical wireless communication channel between a transmitter and a receiver may be represented by a random time-varying impulse response, a detailed description of which can be found in Non patent literature (NPL) 1. To expound a little more, a single pulse transmitted over a multipath wireless channel may be received as a train of pulses, wherein each pulse in the train denotes one multipath component. Each multipath component may experience events like reflection, refraction or scattering from the surrounding scatterers in the transmission path, thus undergo phase changes, leading to their constructive or destructive addition at the receiver. Such a phenomenon may be called multipath fading.

Furthermore, each multipath component may reach the receiver with different time delays. The knowledge of the instantaneous channel condition can be exploited effectively to improve communication performance. More specifically, the capacity of the fading channel may depend on the knowledge about the time-varying wireless channel at the transmitter and/or receiver. For example, the channel information at the transmitter is extremely useful for employing performance enhancing techniques, including but not limited to, power allocation, beamforming or scheduling operations.

Acquiring knowledge about the time-varying channel can be done by a method like channel estimation. In one such method, a reference signal (for example, a sounding reference signal (SRS)) already known to the receiver may be transmitted by the transmitter, enabling the receiver to compute the channel transfer function, more specifically, impulse response or frequency response of the channel. Furthermore, there are techniques to obtain the knowledge about channel response at the transmitter side: for example, employing a time division duplexing (TDD) method or a frequency division duplexing (FDD) method.

In one exemplary form of communication, signal transmission and reception between a base station (BS) and a mobile user equipment (UE) may be considered. In such a scenario, the signal transmission from the UE to BS may be called as uplink (UL) communication, while that from the BS to the UE may be called downlink (DL) communication. It is known that in the TDD method, the UL communication channel and the DL communication channel may follow channel reciprocity, thus enabling the estimated channel response in UL channel be exploited for DL transmission. Not restricted to TDD, there may be techniques to achieve channel reciprocity in FDD method as well, for example, by employing a frequency correction algorithm based on channel characteristics, including but not limited to direction of arrival, channel covariance matrix or channel space-time correlation etc.

However, in many practical communication systems, there may be a time gap between the UL channel estimation instant and the DL transmission instant. It is possible that the time-varying wireless channel changes in this duration, which can introduce inaccuracy in the performance-enhancing techniques employed in DL transmission based on the estimated UL channel response as described in Non patent literature (NPL) 2.

### CITATION LIST

### Non Patent Literature

NPL 1: A. Goldsmith, Wireless Communications. Cambridge, U.K.: Cambridge Univ. Press, 2005
NPL 2: A. Duel-Hallen, Shengquan Hu and H. Hallen, “Long-range prediction of fading signals,” in IEEE Signal Processing Magazine, vol. 17, no. 3, pp. 62-75, May 2000, doi: 10.1109/79.841729

### SUMMARY

### Technical Problem

In a typical multi-user multiple-input multiple-output (MU-MIMO) communication system, a BS may need the DL channel information corresponding to each UE. For example, such channel information may be efficiently used to suppress the interference occurring between multiple users or multiple transmission streams. Precise knowledge of the DL channel information at the time of downlink transmission may lead to accurate interference-cancellation operation by correct beamforming weight calculation. However, there may be a time delay between the time instant at which channel estimation is performed at the BS and the time instant at which DL signal transmission takes place. It may happen that a time-varying wireless channel response changes during this interval. Hence, an older value of channel information may get used for beamforming weight calculation. Such inaccurate beamforming weight used in downlink transmission can result in throughput degradation due to the reasons discussed earlier.

Specifically, the 3^{rd} generation partnership project (3GPP) has decided to work on the evolution of MIMO in the 3GPP Release 18. In practical implementations of an MU-MIMO system, performance degradation may occur due to the use of outdated channel response in the downlink transmission from a base station (BS) to a user equipment (UE) when the UE is moving with medium to high velocity.

There can be methods to predict the channel response (for example, channel impulse response, or channel frequency response, or some variant that contains information related to the channel) at the time of signal transmission. Such prediction may be based on the past values of channel response, measured at the time of channel estimation. Based on the predicted channel response, at least one of a singular value decomposition (SVD) or eigenvalue decomposition (EVD) may be done to compute at least one of a singular vector or eigen vector. The singular vector or eigen vector thus obtained may be used for beamforming. Thus, if channel prediction is used to predict the channel response at some time-slots where beamformed signal transmission is intended, then it may be necessary to perform an SVD or an EVD in those time-slots. However, an SVD or an EVD may impose high computational complexity.

An exemplary objective of the present disclosure is to predict at least one of a singular vector or an eigenvector of the channel response (for example, channel impulse response, or channel frequency response, or some variant that contains information related to the channel) at the time of beamformed signal transmission. More specifically, a channel response (impulse response or frequency response) matrix may be calculated at the time of channel estimation. Such calculation of channel estimation may be done based on a received SRS or pilot signal. Then, at least one of an SVD or EVD may be performed to compute the singular vector or eigen vector at the time-slot of channel estimation. Then, based on the computed singular vector or eigen vector at the time-slot of channel estimation, a predicted singular vector or eigen vector may be obtained in the time-slot where no channel estimation is performed but a downlink transmission is scheduled. An advantage of the present invention is that it will make it unnecessary to perform an SVD or EVD operation in the time-slot where no channel estimation is performed but a downlink transmission is scheduled.

### Solution to Problem

According to an aspect of the present invention, a communication device includes: a wireless transceiver configured to communicate with another communication device through a wireless channel; and at least one processor configured to execute instructions to: a) estimate at least two channel response matrices of the wireless channel based on a predetermined signal received from the another communication device; b) obtain at least two first eigenvectors or singular vectors of the channel response matrices; and c) predict at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

According to another aspect of the present invention, a channel prediction method by at least one processor in a communication device including a wireless transceiver, wherein the wireless transceiver is configured to communicate with another communication device through a wireless channel, the method includes: a) estimating at least two channel response matrices of the wireless channel based on a predetermined signal received from the another communication device; b) obtaining at least two first eigenvectors or singular vectors from the at least two channel response matrices; and c) predicting at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

As described above, according to the present invention, the second eigenvector or singular vector of the wireless channel can be predicted at the time of signal transmission. Accordingly, using such a predicted eigenvector or singular vector at the time instant of signal transmission, accurate signal transmission can be achieved.

The disclosure accordingly comprises the several steps and the relation of one or more of such steps with respect to each of the others, and the apparatus embodying features of construction, combinations of elements and arrangement of parts that are adapted to affect such steps, all is exemplified in the following detailed disclosure, and the scope of the disclosure will be indicated in the claims. In addition to the objects mentioned, other obvious and apparent advantages of the disclosure will be reflected from the detailed specification and drawings.

### BRIEF DESCRIPTION OF DRAWINGS

FIG. 1 is a diagram illustrating an operation of uplink transmission from a UE to a BS in a wireless communication system to which an exemplary embodiment of the present invention is applicable.

FIG. 2 is a diagram illustrating an operation of downlink transmission from BS to UE in a wireless communication system to which an exemplary embodiment of the present invention is applicable.

FIG. 3 is a diagram illustrating an uplink transmission from UE to BS in a typical multipath wireless propagation environment in a wireless communication system to which an exemplary embodiment of the present invention is applicable.

FIG. 4 is a schematic diagram illustrating the problem of calculation of downlink beamforming weights that causes channel aging in a wireless communication system.

FIG. 5 is a representative plot of average user throughput against uplink SRS transmission interval demonstrating the performance degradation caused by aging of wireless channel.

FIG. 6 is a schematic diagram for explaining the problem of calculation of downlink beamforming weights resulting in high complexity.

FIG. 7 is a schematic diagram illustrating an example of a proposed solution of eigenvector prediction.

FIG. 8 is a graph illustrating an example of channel gains at different angles of each multipath component for explaining a multipath resolution according to the proposed solution.

FIG. 9 is a graph illustrating an example of channel gains at different delays of each multipath component for explaining a multipath resolution according to the proposed solution.

FIG. 10 is a graph illustrating an example of channel gains at different Doppler frequencies of each multipath component for explaining a multipath resolution according to the proposed solution.

FIG. 11 is a schematic diagram illustrating a functional configuration of a BS device according to an exemplary embodiment of the present invention.

FIG. 12 is a schematic diagram illustrating a functional configuration of a UE terminal which can communicate with the BS device according to the exemplary embodiment of the present invention.

FIG. 13 is a sequence diagram illustrating a series of frame transmission and operations of a wireless communication system according to the exemplary embodiment of the present invention.

FIG. 14 is a flowchart illustrating operations for eigenvector or singular vector prediction in subcarrier and antenna domains, according to the exemplary embodiment of the present invention.

### DETAILED DESCRIPTION

Hereinafter, the word “exemplary” is used herein to mean “serving as an example, instance, or illustration”. Any embodiment described herein as “exemplary” is not necessarily to be construed as preferred or advantageous over other embodiments.

### 1. OUTLINE OF EXEMPLARY EMBODIMENTS

The technical problems of the background art as discussed earlier can be solved by predicting at least one of a singular vector or eigenvector of a channel response matrix of a time-varying wireless channel at a time instant of signal transmission based on the singular vector or eigenvector of the channel response matrix computed at one or more past events of channel estimation. Predicting the singular vector or eigen vector can be done by an extrapolation operation. More specifically, it may be possible to obtain the singular vector or eigenvector at a time-slot where no channel estimation is performed but beamformed signal transmission is desired.

Accordingly, the predicted eigenvector of the wireless channel can be used to perform accurate beamforming-based signal transmission at the time instant where no channel estimation is performed. It is thus possible to compensate for performance degradation (in terms of metrics like user throughput among many others) that occurs when the beamforming weights are computed using old and obsolete channel information.

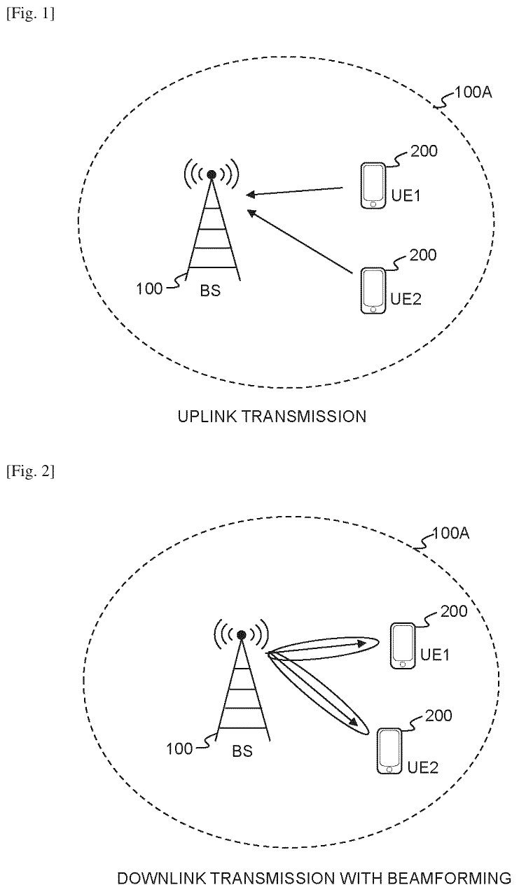

It should be noted that for an extrapolation operation which can be used in some exemplary embodiments of the proposed method, techniques including but not limited to linear extrapolation, linear regression, least-square estimation, non-linear regression, polynomial regression, spline regression, curve fitting etc. may be adopted, and all occurrences of the word “extrapolation” anywhere in this disclosure may be construed to be inclusive of these methods but not limited to them. Hereafter, the outline of a channel prediction method according to the present exemplary embodiments will be described by referring to FIGS. 1-14.

### 1.1) System Configuration

As illustrated in FIGS. 1 and 2, a wireless communication system is composed of a plurality of communication devices where a specific communication device such as a base station (BS) or an access point may communicate with other communication devices. For simplicity, it is assumed that a BS device 100 is capable of communicating with a plurality of UE terminals 200 including two UE terminals UE1 and UE2. The UE terminals UE1 and UE2 are located within a radio coverage area (cell) 100A formed by the BS 100, allowing each UE terminal to perform uplink (UL) transmission and the BS device 100 to perform downlink (DL) transmission with beamforming.

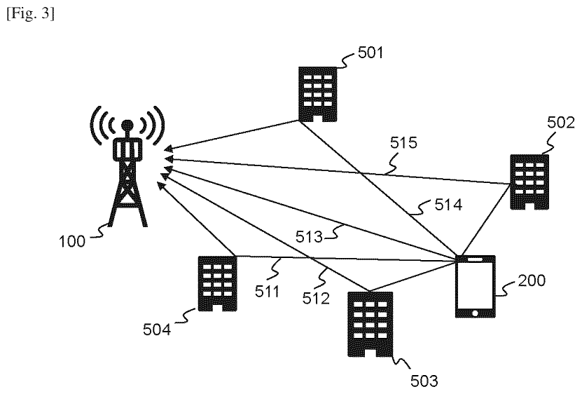

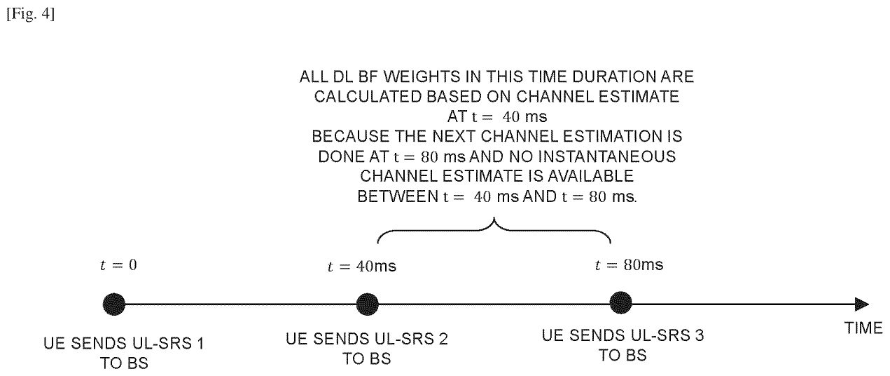

Illustrated in FIG. 3 is a typical multipath propagation environment in wireless communications. An uplink signal transmitted by the UE terminal 200 reaches the BS device 100 over multiple paths (five such paths are shown in FIG. 3), each path representing a copy of the signal with some attenuation and delay. The BS device 100 receives a sum of the signal copies of all paths.

Beamforming techniques are employed by multi-antenna transmitters to provide directivity to a transmission, and thus enabling spatial multiplexing of a plurality of signals. Such mechanism can be used for a multi-user MIMO system such that a multi-antenna BS (BS device 100) can simultaneously transmit a plurality of signals destined for different users (UE terminals 200). Beamforming can be implemented by analog or digital methods. In an analog beamforming method, different amplifiers and phase-shifters may be used for the same analog signal in radio frequency to vary their amplitude and phase corresponding to each transmit antenna. Thus, power variation and beam steering become possible.

Alternatively, in digital beamforming, different digital baseband signals may be constructed for each transmit antenna by multiplying with different weight coefficients. For digital beamforming, the transmitter of the BS device 100 may need information about the channel between itself and the receiver of each UE terminal 200, to design effective beamforming weight. For obtaining the channel information, techniques like channel estimation may be employed. In a typical channel estimation technique, a known reference signal may be transmitted from the UE terminal 200 to the BS device 100. The BS device 100 may use this known reference signal to compute the channel impulse response or frequency response.

### 1.2) Performance Degradation

Sending the known reference signal too often (for example, more than a predetermined number of times in a given interval of time) can increase the overhead associated with channel estimation, and reduce the opportunity for actual data communication. However, if the channel estimation is performed at large time intervals, then the condition of the time-varying wireless channel may change in the meantime, which can make the channel estimation information obsolete at the time of next transmission. Such a situation is illustrated in FIG. 4.

In FIG. 4, the UE terminal 200 sends an uplink SRS (UL-SRS) to the BS device 100 at intervals of 40 ms (milliseconds). The BS device 100, each time receiving a UL-SRS, calculates the digital beamforming (BF) weight based on channel estimation. The wireless channel between the BS device 100 and UE terminal 200 may vary with time due to the movement of the UE terminal 200, or for other reasons contributing to variation of wireless channel. When the condition of the wireless channel between the BS device 100 and the UE terminal 200 changes within a duration of 40 ms between t=0 (the time instant when UE sends UL-SRS 1 and BS receives it) and t=40 ms (the time instant when UE sends UL-SRS 2 and BS receives it), the BS device 100 may not have the knowledge of the latest channel response. In such a situation, the BS device 100 may have to reuse the beamforming weight calculated at the preceding channel estimation event till the next channel estimation event. For example, the BS device 100 may compute a channel estimate and beamforming weight at t=0, and may continue to use the same beamforming weight for downlink transmission till the next channel estimation event is performed at t=40 ms. Accordingly, use of obsolete channel estimation results and digital beamforming weights by the BS device 100 may result in performance degradation caused by factors such as inefficient interference cancellation between the spatially multiplexed streams and interference between signals destined for different UE terminals.

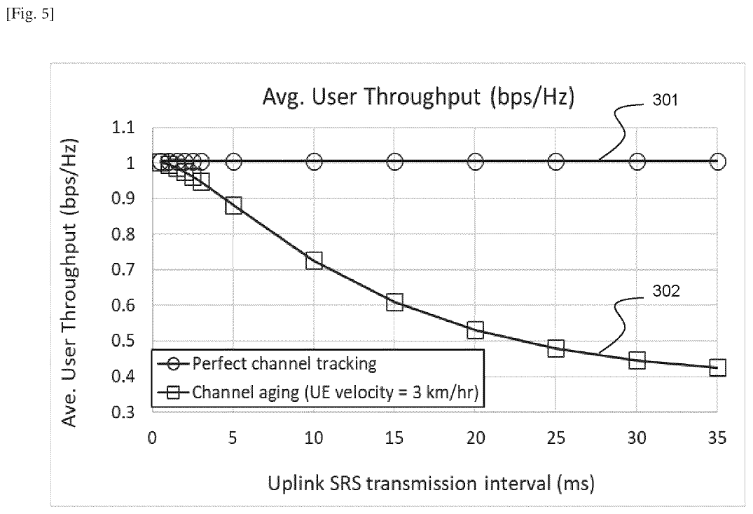

As illustrated in FIG. 5, an exemplary scenario of performance degradation due to channel aging is presented. In FIG. 5, the average user throughput in bits/see/Hz is plotted against the time interval between two successive transmissions of uplink SRS in millisecond. The UE terminal 200 is assumed to be moving at a velocity of 3 km/hr. It is observed that there is no degradation in average user throughput when the channel is perfectly tracked at the BS device 100 (as shown by reference numeral 301), meaning, the channel response is perfectly and accurately known to the BS device 100 in every time slot. This happens because the BS device 100 can compute accurate beamforming weights for downlink transmission using the exact value of channel impulse response or channel frequency response, resulting in efficient interference cancellation between spatially multiplexed streams and users.

However, in the case where the perfect channel tracking is not possible, the time-varying wireless channel changes between the time instant at which the beamforming weights are computed and the time instant at which downlink transmission occurs. Thus, because of channel aging and inaccurate beamforming weights, the average user throughput is found to degrade which is shown by reference numeral 302.

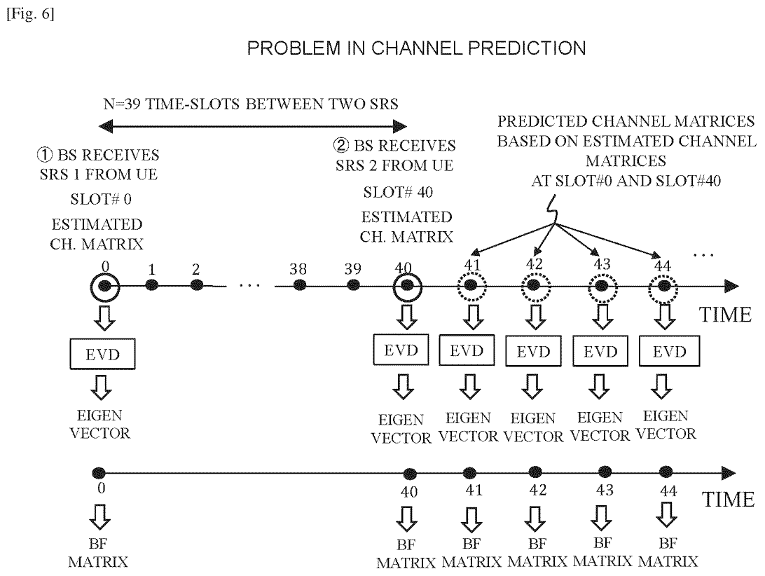

Referring to FIG. 6, a problem of channel prediction is described. According to this channel prediction, a channel response matrix is predicted in the time slots where no channel estimation is performed. Subsequently, an SVD or EVD operation is performed to obtain the eigenvectors, which are then used for beamforming. For example, the BS device 100 may receive a first uplink SRS (SRS 1) at time slot=0, and a second SRS (SRS 2) at time slot=40. Accordingly, channel estimation can be performed at time slot=0 and time slot=40 to obtain the corresponding estimated channel response matrices at time slot=0 and time slot=40, respectively. Let us consider that the next channel estimation is performed when SRS is received at time slot=80 (not shown in FIG. 6). Then, for a time slot greater than 40 but less than 80, the channel response matrix is predicted to reduce the performance degradation caused by channel aging. More specifically, based on the two past channel response matrices obtained by channel estimation operations at time slot=0 and time slot=40, the channel response matrices may be predicted at time slots=41, 42, . . . , 79. Then, at least one of an SVD or EVD operation may be performed on the predicted channel matrices at each of the time slots=41, 42, . . . , 79, respectively. Thus, precoded beamformed transmission may be possible at time slots=41, 42, . . . , 79 Hence, the channel prediction method as shown in the example of FIG. 6 may require SVD or EVD operations at all time slots where channel prediction is performed, specifically at time slots=41, 42, . . . , 79 However, an SVD or EVD operation may have high complexity. Hence it may be preferable to reduce the number of SVD or EVD operations.

### 1.3) Proposed Solution

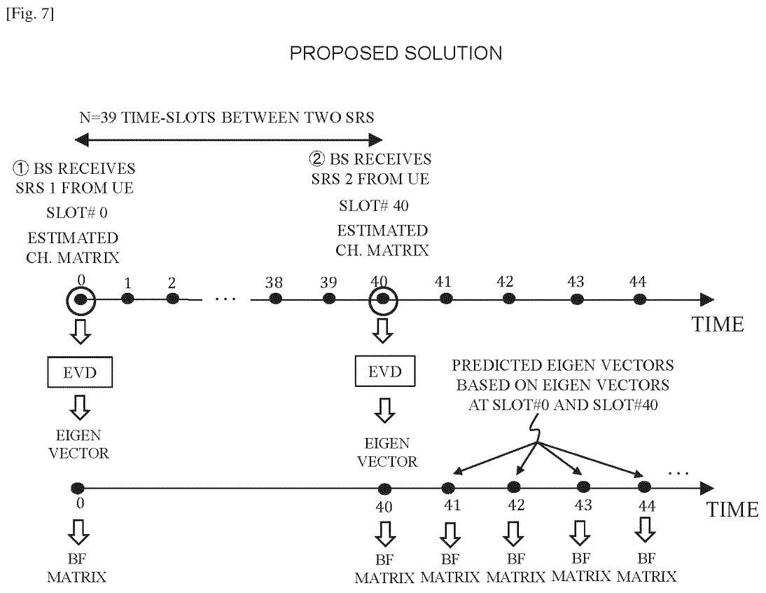

It may be possible to solve the above-described problem by predicting at least one eigenvector of the channel response matrix at the time instants where channel prediction is desired, according to an exemplary embodiment of the present invention. This is described with an example in FIG. 7. More specifically, with reference to FIG. 7, instead of predicting the channel response matrix at every time slot of downlink transmission, it is proposed that the eigen vector is predicted. By virtue of this proposal, it is not necessary to perform the complex operations of SVD or EVD at every time slots of downlink transmission where no channel estimation is performed. In the proposed method, SVD or EVD operation is performed only at the time slots of channel estimation. Thus, the total number of SVD or EVD operations between two channel estimation instants is significantly reduced, which reduces the complexity of the system.

As illustrated in FIG. 7, the UE terminal 200 sends an uplink SRS as a reference signal at predetermined intervals which can be periodic (e.g. 40 ms) or aperiodic as well. Each time the BS device 100 receives the uplink SRS, a channel response matrix between the UE terminal 200 and the BS device 100 is computed by channel estimation. For example, the BS device 100 receives uplink SRS at time slot 0 and time slot 40. The BS device 100 then computes the estimated channel matrices at time slot 0 and time slot 40, respectively. Subsequently, at least one of an SVD or EVD operation is performed on the estimated channel response matrices to obtain the eigenvectors at time slot 0 and time slot 40, respectively. Then, based on the eigenvectors computed at time slot 0 and time slot 40, eigenvectors are predicted at each of the time slots=41, 42, . . . , 79, respectively. Thus, precoded beamformed transmission may be possible at time slots=41, 42, . . . , 79 Hence, the proposed method as shown in the example of FIG. 7 may require SVD or EVD operations only at the time slots where uplink SRS is received and channel estimation is performed (in this example, time slots=0 and 40). However, no SVD or EVD operation is performed in the time slots where channel estimate is unavailable (in this example, time slots=41 to 79). This reduces the overall system complexity.

The prediction operation of eigenvectors may be performed by at least one extrapolation method such as a linear extrapolation, linear regression, least-square estimation, non-linear regression, polynomial regression, spline regression and curve fitting. In some embodiments, a simple linear extrapolation may be employed based on two or more past instances of an element of eigenvectors to predict a future value. In some embodiments, the prediction of eigenvectors may be carried out by employing machine learning techniques, including but not limited to a long short-term memory (LSTM) model, a transformer model, or a reinforcement learning (online learning). Treating the time-variation of eigenvectors or singular vectors as time-series, long short-term memory (LSTM) model can be used for prediction of eigenvectors. LSTM is a recurrent neural network (RNN) capable of learning long short-term dependencies in time-series which can be used in eigenvector prediction by treating the eigenvectors obtained at the channel estimation instants as a time series. Furthermore, a transformer model can also be used for time-series prediction of eigenvectors or singular vectors. Time series forecasting of eigenvectors or singular vectors may also be performed employing online reinforcement learning by continuously updating the best predictor based on the available data, instead of batch learning.

Hereafter, without loss of generality, a channel response obtained by channel estimation based on a reference signal may be referred to as an estimated channel response matrix as appropriate. An eigenvector or singular vector obtained from the estimated channel response matrix may be referred to as a first eigenvector or singular vector. On the other hand, an eigenvector or singular vector obtained by prediction based on previously obtained eigenvectors or singular vectors may be referred to as a predicted eigenvector or singular vector as appropriate. In generality, an input of the prediction process may be referred to as first eigenvectors or singular vectors and an output of the prediction process may be referred to as second eigenvector or singular vector. Note that prediction of eigenvectors or singular vectors may comprise of predicting the amplitude and phase of the predicted eigenvector or singular vector, or predicting the real and imaginary values of the predicted eigenvector or singular vector.

### <Multipath Propagation Environment>

As illustrated in FIG. 3, the UE terminal 200 sends UL-SRS in a multipath propagation environment. Without loss of generality, let us consider UL-SRS as a reference signal. The UL-SRS travels in separate paths denoted by reference numerals 511-515 while reflecting from objects such as buildings 501-504. Accordingly, UL-SRSs that reach the BS device 100 may take different routes, thereby reaching the BS device 100 at different times and different angles. In addition, the UE terminal 200 may move closer to or away from the BS device 100. In such a case, the Doppler effect may be considered.

To perform channel prediction for a time-varying wireless channel in the multipath propagation environment, it may be useful to resolve the received superposed signal into constituent multipath components at first. Following a multipath resolution, the amplitude and phase of each multipath component may be computed. Such a computation may be performed during channel estimation events, based on the received known reference signals.

Efficient separation of the multipath components may be crucial for accurate channel prediction. For instance, the multipath components can be separated based on their angle profile or delay profile, or Doppler profile.

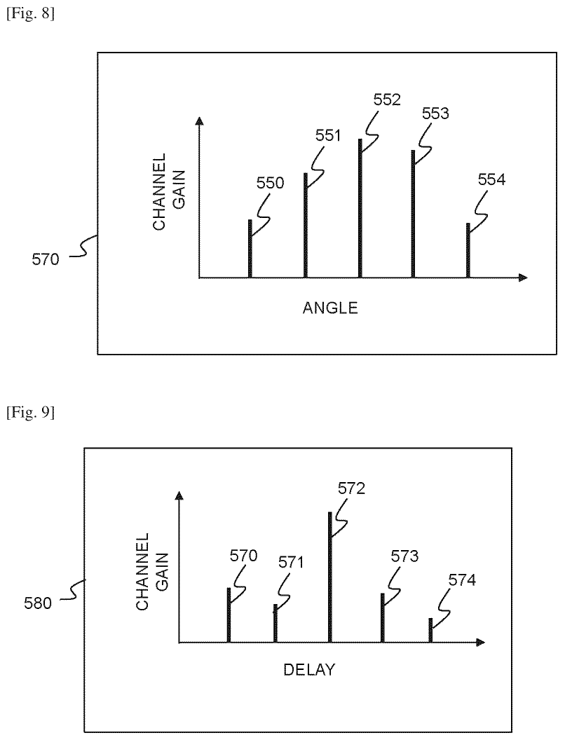

With reference to FIG. 8, the separation of multipath components based on angle is explained. In some examples, we may refer to the angle domain as beamspace domain. Five multipath components 550, 551, 552, 553, and 554 have different angles from each other. Thus, their channel gains can be obtained separately in the angle domain. In a similar fashion, the phase of each of the five multipath components may also be obtained separately.

Furthermore, with reference to FIG. 9, the separation of multipath components based on delay is explained. Five multipath components 570, 571, 572, 573, and 574 have different delays from each other. Thus, their channel gains can be obtained separately in the delay domain. In a similar fashion, the phase of each of the five multipath components may also be obtained separately.

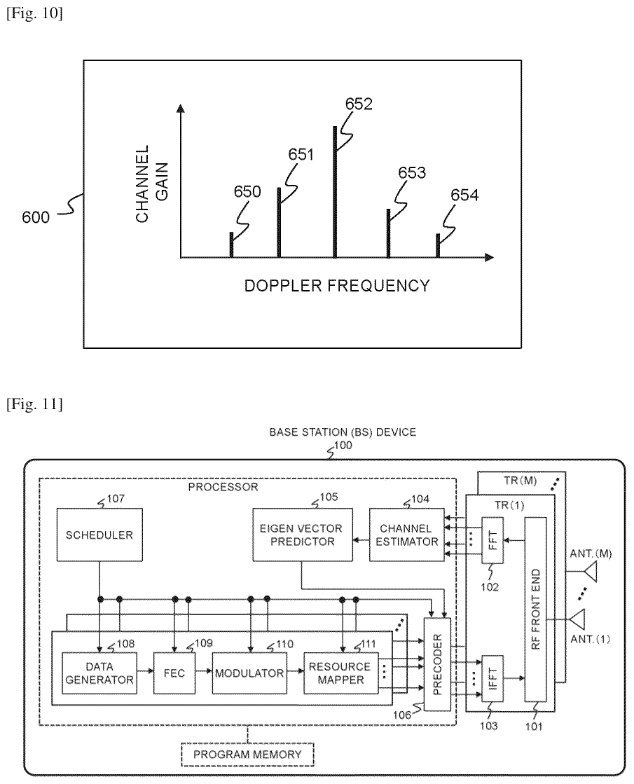

According to an embodiment of the present disclosure, it may be possible to separate the multipath components based on their Doppler frequency. Such multipath separation in Doppler domain is explained using the example in FIG. 10. Five multipath components 650, 651, 652, 653, and 654 have different Doppler frequencies from each other. Thus, their channel gains can be obtained separately in the Doppler domain. In a similar fashion, the phase of each of the five multipath components may also be obtained separately.

### 2. EXEMPLARY EMBODIMENTS

Hereafter, an implementation of the above-mentioned prediction method will be described in detail.

### 2.1) System Configuration

As illustrated in FIG. 11, the BS device 100 has an array antenna composed of M antennas ANT.(1)-ANT.(M), where M is an integer greater than one. The antennas ANT.(1)-ANT.(M) are connected to wireless transceivers TR(1)-TR(M), respectively. Each wireless transceiver includes a RF (Radio Frequency) front end 101, a fast Fourier transform (FFT) section 102, and an inverse FFT (IFFT) section 103. The RF front end 101 inputs a RF received signal from a corresponding antenna and outputs a sequence of received data to the FFT section 102. The RF front end 101 inputs a sequence of transmission data from the IFFT section 103 and outputs a RF transmission signal to the corresponding antenna. The FFT section 102 decomposes the sequence of received data to frequency components. The IFFT section 103 composes a sequence of transmission data from frequency components.

The BS device 100 further includes a channel estimator 104, an eigen vector predictor 105 and a precoder 106. The channel estimator 104 inputs frequency components of a UL-SRS from the FFT section 102 of each radio transceiver and outputs channel estimation signals to the eigen vector predictor 105. The eigen vector predictor 105 predicts eigen vectors of the channel response matrices at time instants where no channel estimation is performed. The prediction may be done by the eigen vector predictor 105 based on two or more past eigen vectors as described before (see the example in FIG. 7). The eigen vector predictor 105 outputs the predicted eigen vectors to the precoder 106.

The BS device 100 further includes a scheduler 107 and a plurality of data processing sections, each of which implements functions of a data generator 108, a forward error correction (FEC) section 109, a modulator 110 and a resource mapper 111. The scheduler 107 decides which users are scheduled for DL transmission in a given time slot. The data generator 108 generates transmission data, which is subjected to FEC at the FEC section 109. The modulator 110 modulates the output of the FEC section 109 to output modulated transmission data to the resource mapper 111. The resource mapper 111 performs resource-mapping of transmission data to output frequency components to the IFFT 103 of each transceiver through the precoder 106. The precoder 106 performs precoding according to the predicted eigen vectors received from the eigen vector predictor 105. As described before, the eigen vector prediction can be done for future time slots and the predicted eigen vectors are stored in a memory. Or the eigen vector prediction can be done in real time in each time slot.

In FIG. 11, the functions as denoted by reference numerals 104-111 may be implemented by a processor or a central processing unit (CPU) running programs stored in a program memory. The programs include an eigen vector prediction program which can implement the function of the eigen vector predictor 105.

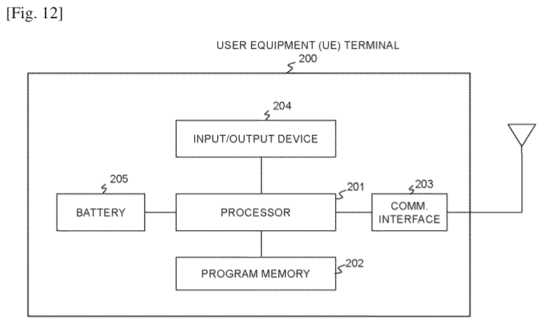

As illustrated in FIG. 12, the UE terminal 200 includes a processor 201, a program memory 202, a communication interface 203, an input/output device 204, and a battery 205. The processor 201 runs programs stored in the program memory 202 to control UE operations including UL-SRS transmission. The UL-SRS transmission is performed in response to the signaling from the BS device 100. When the UE terminal 200 is located within the radio coverage of a network device such as the BS device 100, the communication interface 203 can connect to the network device by a radio channel. Furthermore, the power for running all operations in the UE terminal (such as running the processor 201, transmitting/receiving signals using the communication interface 203 and other power-driven operations) may be drawn from the battery 205.

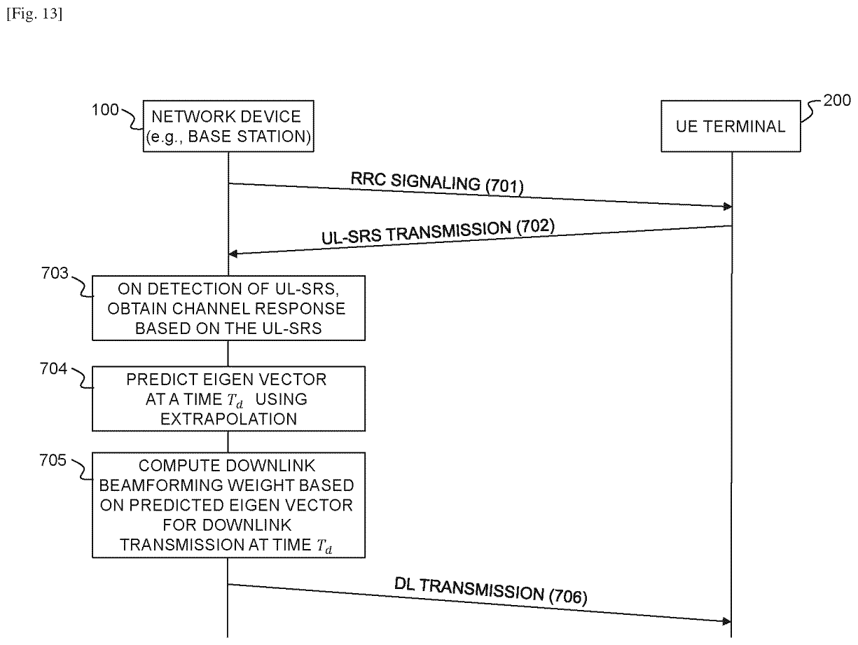

With reference to FIG. 13, an exemplary frame sequence diagram is shown between a network device (for e.g., the BS device 100) and the UE terminal 200. In one particular example, the BS device 100 may send a radio resource control (RRC) signal to the UE terminal 200 as indicated by reference numeral 701. The UE terminal 200 may send an UL-SRS to the BS device 100 as indicated by reference numeral 702. On detection of the UL-SRS, the BS device 100 may obtain the channel response (for example, channel impulse response, channel frequency response, or some other information related to the channel condition) between the BS device 100 and the UE terminal 200 based on the UL-SRS as described in the step 703. The channel response may be represented in the form of a matrix. At least one of an SVD and EVD operation may be performed on the channel response matrix to obtain at least one singular vector or eigen vector. Based on one or more eigen vectors obtained from the UL-SRS, the eigen vector at a time instant Ta where no channel estimation is performed may be predicted using an extrapolation operation as described in the step 704. Furthermore, based on the predicted eigen vector, a downlink beamforming weight for downlink transmission at the time instant Ta may be computed as shown in the step 705. Finally, a downlink signal may be sent from the BS device 100 to the UE terminal 200 as indicated by reference numeral 706 by employing the downlink beamforming weight.

2.2) Description of Eigenmode Transmission Using SVD or EVD with Perfect Channel Tracking

Hereinafter, some examples of SVD and EVD operations are provided, and a typical eigenmode transmission with perfect channel tracking is described. Here, perfect channel tracking may imply that a transmitter has perfect knowledge of the time-varying wireless channel with a given receiver (or equivalently, the channel response matrix between the transmitter and the receiver) in each time-slot where a transmission is intended to the receiver. Let us assume that the estimated channel response matrix at the BS device 200 is an N_{R}×N_{T} sized matrix H. An EVD operation may be performed for square matrices. An SVD operation, however, is a more general operation and can be performed on a general matrix, including non-square matrices. SVD of matrix H may be expressed as

$$H = {USV}^{H} , \qquad ( Math . 1 )$$

$$H = [ \begin{matrix}{u}_{1} & {u}_{2} & … & {u}_{{N}_{r}}\end{matrix} ] [ \begin{matrix}{s}_{1} & 0 & 0 \\ 0 & ⋱ & 0 \\ 0 & 0 & {s}_{{N}_{T}}\end{matrix} ] [ \begin{matrix}{v}_{1}^{H} \\ {v}_{2}^{H} \\ ⋮ \\ {v}_{{N}_{T}}^{H}\end{matrix} ] , \qquad ( Math . 2 )$$

$$where ,$$

$${U}^{H} U = I , and \qquad ( Math . 3 )$$

$${V}^{H} V = {VV}^{H} = I .$$

The (·)^{H} operation denotes a Hermitian operation. For real matrices, a transpose operation may be used equivalently in place of the Hermitian operation. The above-described equations (Math. 2) and (Math. 3) may hold true when the number of receiver antennas is greater than or equal to the number of transmitter antennas. The matrix I (for example, in (Math. 3)) denotes an identity matrix.

$${u}_{1} , {u}_{2} , … , {u}_{{N}_{T}} \qquad ( Math . 4 )$$

are the column vectors of matrix U. Furthermore,

$${v}_{1} , {v}_{2} , … , {v}_{{N}_{T}} \qquad ( Math . 5 )$$

are the column vectors of matrix V. Thus, U and V are orthogonal matrices of sizes (N_{R}×N_{T}) and (N_{T}×N_{T}), respectively. The columns of U may be referred to as left singular vectors, while the columns of V may be referred to as right singular vectors. The matrix S in (Math. 1) may be of the same size as matrix H, and S contains the singular values of the matrix H. The calculation of SVD of matrix H as expressed in (Math. 1) may be equivalently done by doing EVD of a matrix H^{H}H and a matrix HH^{H}. In such case, the columns of the matrix V may be obtained from the eigen vectors of the matrix H^{H}H. Also, the column vectors of the matrix U may be obtained from the eigen vectors of matrix HH^{H}. Furthermore, the singular values contained in matrix S as defined in (Math. 1) may be obtained from the square roots of eigenvalues from the matrices H^{H}H or HH^{H}.

An example of an SVD operation is shown here using a non-square matrix. Consider a (2×3) channel response matrix be defined as

$$H = [ \begin{matrix}3 & 2 & 2 \\ 2 & 3 & - 2\end{matrix} ] . \qquad ( Math . 6 )$$

The singular values of H may be obtained by computing the square root of the eigenvalues of matrix HH^{H}, where HH^{H} is expressed as

$${HH}^{H} = [ \begin{matrix}17 & 8 \\ 8 & 17\end{matrix} ] . \qquad ( Math . 7 )$$

The eigenvalues can be solved by equating the characteristic polynomial to zero, as shown below.

$$det ( {HH}^{H} - eI ) = 0 , \qquad ( Math . 8 )$$

$$( e - 25 ) ( e - 9 ) = 0 ,$$

$$e = 25 and 9.$$

Here, the det(·) operation in (Math. 8) indicates determinant of a matrix. Then the singular values of H can be obtained by calculating the square roots of the eigenvalues. Considering positive roots, the singular values may be obtained as s₁=5 and s₂=3.

Then, an S matrix may be expressed as

$$s = [ \begin{matrix}5 & 0 & 0 \\ 0 & 3 & 0\end{matrix} ] . \qquad ( Math . 9 )$$

The right singular vectors which are the columns of the V matrix can be obtained from the orthonormal set of eigenvectors of H^{H}H. Firstly, the eigenvalues of H^{H}H may be obtained as 25, 9, and 0. An eigenvector of H^{H}H corresponding to the eigenvalue e=25 may be obtained by finding a unit-norm vector in the kernel of the matrix H^{H}H−25I. The matrix H^{H}H−25I may be expressed as

$${H}^{H} H - 25 I = [ \begin{matrix}- 12 & 12 & 2 \\ 12 & - 12 & - 2 \\ 2 & - 2 & - 17\end{matrix} ] . \qquad ( Math . 10 )$$

Then, a unit norm vector in the kernel of H^{H}H−25I may be expressed as

$${v}_{1} = [ \begin{matrix}1 / \sqrt{2} \\ 1 / \sqrt{2} \\ 0\end{matrix} ] . \qquad ( Math . 11 )$$

Similarly, for the eigenvalue e=9, the corresponding eigenvector of H^{H}H may be obtained as a unit-norm vector in the kernel of H^{H}H−9I. The matrix H^{H}H−9I may be expressed as

$${H}^{H} H - 9 I = [ \begin{matrix}4 & 12 & 2 \\ 12 & 4 & - 2 \\ 2 & - 2 & - 1\end{matrix} ] . \qquad ( Math . 12 )$$

Then, a unit norm vector in the kernel of H^{H}H−9I is

$${v}_{2} = [ \begin{matrix}1 / \sqrt{18} \\ - 1 / \sqrt{18} \\ 4 / \sqrt{18}\end{matrix} ] . \qquad ( Math . 13 )$$

Furthermore, for the eigenvalue e=0, a corresponding eigenvector of H^{H}H may be obtained as a unit-norm vector in the kernel of H^{H}H.

$${H}^{H} H = [ \begin{matrix}13 & 12 & 2 \\ 12 & 13 & - 2 \\ 2 & - 2 & 8\end{matrix} ] . \qquad ( Math . 14 )$$

Then, a unit norm vector in the kernel of H^{H}H is

$${v}_{3} = [ \begin{matrix}2 / 3 \\ - 2 / 3 \\ - 1 / 3\end{matrix} ] . \qquad ( Math . 15 )$$

Then, a V matrix may be expressed as V=[v₁ v₂ v₃] which may be expressed as

$$V = [ \begin{matrix}1 / \sqrt{2} & 1 / \sqrt{18} & 2 / 3 \\ 1 / \sqrt{2} & - 1 / \sqrt{18} & - 2 / 3 \\ 0 & 4 / \sqrt{18} & - 1 / 3\end{matrix} ] . \qquad ( Math . 16 )$$

Lastly, the left singular vectors u₁ and u₂ contained in the 2×2 sized matrix U are obtained as

$$U = [ \begin{matrix}1 / \sqrt{2} & 1 / \sqrt{2} \\ 1 / \sqrt{2} & - 1 / \sqrt{2}\end{matrix} ] . \qquad ( Math . 17 )$$

Thus, the SVD of the matrix H may be expressed as

$$H = {USV}^{H} = [ \begin{matrix}1 / \sqrt{2} & 1 / \sqrt{2} \\ 1 / \sqrt{2} & - 1 / \sqrt{2}\end{matrix} ] [ \begin{matrix}5 & 0 & 0 \\ 0 & 3 & 0\end{matrix} ] [ \begin{matrix}1 / \sqrt{2} & 1 / \sqrt{2} & 0 \\ 1 / \sqrt{18} & - 1 / \sqrt{18} & 4 / \sqrt{18} \\ 2 / 3 & - 2 / 3 & - 1 / 3\end{matrix} ] . \qquad ( Math . 18 )$$

Here, we provide an example of an EVD operation using a square matrix. Consider an H matrix as defined below.

$$H = [ \begin{matrix}2 & - 6 & 0 \\ 3 & 4 & 0 \\ 0 & 0 & 2\end{matrix} ] . \qquad ( Math . 19 )$$

Then the EVD of the matrix H may be expressed as

$$H = [ \begin{matrix}- 6 / \sqrt{52} & 2 / \sqrt{13} & 0 \\ 4 / \sqrt{52} & 3 / \sqrt{13} & 0 \\ 0 & 0 & 1\end{matrix} ] [ \begin{matrix}\sqrt{52} & 0 & 0 \\ 0 & \sqrt{13} & 0 \\ 0 & 0 & 2\end{matrix} ] [ \begin{matrix}0 & 1 & 0 \\ 1 & 0 & 0 \\ 0 & 0 & 1\end{matrix} ] , \qquad ( Math . 20 )$$

$$wherein ,$$

$$U = [ \begin{matrix}- 6 / \sqrt{52} & 2 / \sqrt{13} & 0 \\ 4 / \sqrt{52} & 3 / \sqrt{13} & 0 \\ 0 & 0 & 1\end{matrix} ] , \qquad ( Math . 21 )$$

$$S = [ \begin{matrix}\sqrt{52} & 0 & 0 \\ 0 & \sqrt{13} & 0 \\ 0 & 0 & 2\end{matrix} ] , \qquad ( Math . 22 )$$

$$and$$

$$V = [ \begin{matrix}0 & 1 & 0 \\ 1 & 0 & 0 \\ 0 & 0 & 1\end{matrix} ] . \qquad ( Math . 23 )$$

### 2.3) Precoding at the Transmitter

Here, an example of precoding operation performed at the BS device 100 is provided. Consider x=[x₁, x₂, . . . , x_{N}] be a vector of transmit symbols. For precoding at the transmitter in the BS device 100, the vector x may be multiplied by a matrix V to obtain another vector

$$\tilde{x} \qquad ( Math . 24 )$$

as described below.

$$\tilde{x} = Vx . \qquad ( Math . 25 )$$

Consider the V matrix defined in (Math. 23). Also, let x=[x₁, x₂, x₃]. Then the precoded transmit symbol vector may be obtained as

$$\tilde{x} = [ \begin{matrix}0 & 1 & 0 \\ 1 & 0 & 0 \\ 0 & 0 & 1\end{matrix} ] [ {x}_{1} , {x}_{2} , {x}_{3} ] , \qquad ( Math . 26 )$$

which can be rewritten as

$$\tilde{x} = [ \begin{matrix}0 \\ 1 \\ 0\end{matrix} ] {x}_{1} + [ \begin{matrix}1 \\ 0 \\ 0\end{matrix} ] {x}_{2} + [ \begin{matrix}0 \\ 0 \\ 1\end{matrix} ] {x}_{3} . \qquad ( Math . 27 )$$

Thus, a first transmit symbol x₁ may be multiplied by a first eigen vector, a second transmit symbol x₂ may be multiplied by a second eigen vector, and a third transmit symbol x₃ may be multiplied by a third eigen vector. In some examples, the transmit symbols x₁, x₂, and x₃ may be further multiplied by some power allocation coefficients to enable high capacity. In such scenarios, the optimal power allocation coefficients corresponding to each element of the vector x may be computed based on maximizing some metric such as mutual information. In one example of such optimal power-allocation based precoding operation of transmit symbols, the power-allocated and precoded transmit symbol vector may be expressed as

$$\tilde{x} = [ \begin{matrix}0 \\ 1 \\ 0\end{matrix} ] {c}_{1} {x}_{1} + [ \begin{matrix}1 \\ 0 \\ 0\end{matrix} ] {c}_{2} {x}_{2} + [ \begin{matrix}0 \\ 0 \\ 1\end{matrix} ] {c}_{3} {x}_{3} , \qquad ( Math . 28 )$$

where c₁, c₂, c₃ are power allocation coefficients. In (Math. 28), it is assumed that x₁, x₂, x₃ are symbol points from unit-power constellation. In some examples, a water-filling algorithm or its variant may be used to obtain c₁, c₂, c₃.

### 2.4) Decoupling or Parallelization Operation at Receiver

Here, an advantage of the precoding operation is provided with an example. Performing precoding at the transmitter as described above may enable decoupling of N_{T} different transmit streams coming to the receiver from N_{T} different transmit antennas. For example, a received signal may be represented as

$$y = H \tilde{x} + n , \qquad ( Math . 29 )$$

where n may be zero-mean complex Gaussian noise with variance N₀. Then, y may be multiplied by a matrix UH as

$$\hat{y} = {U}^{H} y . \qquad ( Math . 30 )$$

The above-described equation (Math. 29) may be rewritten as

$$\hat{y} = {U}^{H} {USV}^{H} Vx + {U}^{H} n . \qquad ( Math . 31 )$$

$$\hat{y} = Sx + {U}^{H} n . \qquad ( Math . 32 )$$

Thus, based on (Math. 31), it may become possible to decouple the transmit streams, or cancel the inter-stream interference. Hence, it may be possible to detect each transmit symbol contained in x by looking at each corresponding element in the vector

$$\hat{y} . \qquad ( Math . 33 )$$

In some example, the precoding of transmit symbols using

$$\tilde{x} = Vx \qquad ( Math . 34 )$$

may be performed at the transmitter side, but the operation

$$\hat{y} = {U}^{H} y \qquad ( Math . 35 )$$

may not be performed at the receiver. In such case, we have

$$\hat{y} = USx + n . \qquad ( Math . 36 )$$

Then, a zero-forcing (ZF) receiver or a linear minimum mean square error (LMMSE) receiver may be used for symbol detection from (Math. 36).

2.5) Performance Degradation in Eigenmode Transmission Resulting from Obsolete Value of V Matrix

Here, we provide the description of performance degradation that can occur in eigenmode transmission if perfect channel tracking is not possible. Perfect channel tracking refers to the case when the exact value of channel matrix H is known at the transmitter in every transmission time-slot, which can enable accurate calculation of V matrix for precoding. However, due to overhead associated with SRS transmission, channel estimation may not be possible in every time-slot. Hence, an H matrix estimated at an earlier channel estimation instant may be used till the next channel estimation instant. More, specifically, a precoding matrix V computed from an old H matrix may be used till the next channel estimation instant. Let us denote by V_{old} an old precoding matrix. Also, let us denote by V_{perf} an accurate precoding matrix at a given time-slot if perfect channel tracking was possible.

### Assuming

$$\hat{y} = {U}^{H} y \qquad ( Math . 37 )$$

operation is performed at the receiver, we have

$$\hat{y} = {SV}_{perf}^{H} {V}_{old} x + {U}^{H} n . \qquad ( Math . 38 )$$

$$Alternatively , assuming$$

$$\hat{y} = {U}^{H} y \qquad ( Math . 39 )$$

operation is not performed at the receiver, and a ZF or LMMSE receiver is applied, we have

$$\hat{y} = {USV}_{perf}^{H} {V}_{old} x + n . \qquad ( Math . 40 )$$

As evident from (Math. 38), the decoupling is not possible due to mismatch between V_{perf} and V_{old}. More specifically, it is possible that

$${V}_{perf}^{H} {V}_{old} \neq I . \qquad ( Math . 41 )$$

This mismatch may result in throughput degradation.

An effective solution to the above problem can be to know the matrix V_{perf} at every transmit time-slot. Hence, channel prediction schemes may be employed where past values of the channel response matrix may be used to predict the latest value of channel response matrix. But still to obtain the precoding matrix from the predicted channel response matrix may necessitate an SVD or EVD operation which may have high complexity. Thus, it is necessary to obtain the latest and updated precoding matrix at lower complexity in each transmit time-slot.

### 2.6 Prediction of Eigen Vector

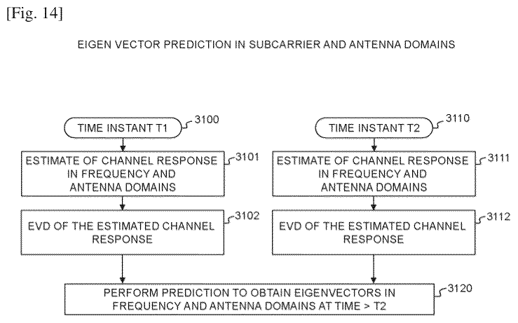

In an exemplary solution to the problem described above, a precoding matrix may be predicted in every transmit time-slot. In this method, performing an SVD or EVD operation in every time-slot may not be necessary. This method is explained with reference to FIG. 14.

In FIG. 14 at a time instant T1 (reference numeral 3100), an uplink SRS may be received at the BS device 100, following which the BS device 100 may estimate a channel response matrix in frequency (subcarrier) and antenna domain (shown in reference numeral 3101). An EVD operation (or SVD operation) may be performed on the estimated channel response matrix as shown by reference numeral 3102. A similar set of options may be performed at a time instant T2 (shown by reference numeral 3110), wherein T2>T1. More specifically, a channel response matrix may be estimated in frequency and antenna domains (as shown by reference numeral 3111), and EVD or SVD may be performed (reference numeral 3112) on the channel response matrix estimated in reference numeral 3111. Based on the eigen vectors or singular vectors or precoding matrices obtained in reference numerals 3102 and 3112, a prediction may be performed (reference numeral 3120) to obtain an eigen vector or singular vector or precoding matrix at a time after T2.

In some exemplary embodiments of the present invention, the prediction may be performed based on more than two past eigen vectors (or singular vectors or precoding matrices). More specifically, the channel estimation may be performed at P different time-slots, namely T1 . . . TP, where P>=2.

In some embodiment, the eigenvector prediction may be done in a transformed domain (another domain different from the antenna-subcarrier domain). For example, at least one of an antenna, subcarrier, delay, beamspace, time, and Doppler domain, or some combination of these domains may be used. For example, the eigenvector prediction may be performed in a delay-beamspace domain, or a delay-Doppler-beamspace domain. Once the eigenvector prediction is performed in a transformed domain, the predicted eigenvector matrix may be transformed back to the antenna-subcarrier domain so that it can be applied for beamformed transmission.

In some exemplary embodiments, the domain transformations may be achieved by employing at least one of a discrete Fourier transform (DFT) or an inverse discrete Fourier transform (IDFT) as follows:
a) Antenna domain to beamspace domain: DFT along antenna indices,
b) Subcarrier domain to delay domain: IDFT along subcarrier indices,
c) Time domain to Doppler domain: DFT along time indices,
d) Beamspace domain to antenna domain: IDFT along beam indices,
e) Delay domain to subcarrier domain: DFT along delay tap indices, and
f) Doppler domain to time domain: IDFT along Doppler tap indices.

Furthermore, some embodiments may use a fast Fourier transform (FFT) or inverse fast Fourier transform (IFFT) algorithm for implementing the DFT and IDFT operations respectively.

In some exemplary embodiments, the prediction operation (reference numeral 3120) may be performed by a linear extrapolation as described herein. Assume that a1+jb1 is an element of an eigen vector obtained at time T1 in the step 3102 of FIG. 14, where a1 is the real part, b1 is the imaginary part, and j is square root of minus one. Furthermore, assume that a2+jb2 is an element of an eigen vector obtained at time T2 in the step 3112 of FIG. 14. Then the predicted value of real part at time T3 where T3>T2 may be computed as

$$a 1 = \frac{( T 3 - T 1 )}{( T 2 - T 1 )} \times ( a 2 - a 1 ) . \qquad ( Math . 42 )$$

Similarly, the predicted value of imaginary part at time T3 where T3>T2 may be computed as

$$b 1 + \frac{( T 3 - T 1 )}{( T 2 - T 1 )} \times ( b 2 - b 1 ) . \qquad ( Math . 43 )$$

In some exemplary embodiments, for instance in embodiments where no domain-transformation is employed, the prediction or extrapolation may be preferred in the complex number format as described above. More specifically, if the elements of an eigenvector are complex numbers, then the real part and imaginary part of a complex number can be extrapolated separately. Here, ‘domain-transformation’ may imply transforming from a first domain to a second domain, for example, from antenna domain to beamspace domain, or from frequency (subcarrier) domain to delay domain, or from time domain to Doppler domain etc. By doing extrapolation in complex number format, a better performance (for example, better throughput) may be observed in some cases where no domain-transformation is used.

Furthermore, in some embodiments, the values a₁+jb₁ and a₂+jb₂ may be first converted into a magnitude and phase format. More specifically, the magnitude of a₁+jb₁ may be obtained as

$${r}_{1} = \sqrt{{a}_{1}^{2} + {b}_{1}^{2}} \qquad ( Math . 44 )$$

and the phase of a₁+jb₁ may be obtained as

$${ϕ}_{1} = {tan}^{- 1} ( \frac{{b}_{1}}{{a}_{1}} ) degree , if {a}_{1} \geq 0 , {b}_{1} \geq 0 , \qquad ( Math . 45 )$$

$${ϕ}_{1} = 180 - {tan}^{- 1} ( \frac{{b}_{1}}{{a}_{1}} ) degree , if {a}_{1} < 0 , {b}_{1} > 0 ,$$

$${ϕ}_{1} = 180 + {tan}^{- 1} ( \frac{{b}_{1}}{{a}_{1}} ) degree , if {a}_{1} < 0 , {b}_{1} < 0 ,$$

$${ϕ}_{1} = - {tan}^{- 1} ( \frac{{b}_{1}}{{a}_{1}} ) degree , if {a}_{1} > 0 , {b}_{1} < 0.$$

Similar to a₁+jb₁, the magnitude and phase of a₂+jb₂ may also be obtained in magnitude and phase format. More specifically, r₂ and Phi₂ (Phi is a lower-case Greek alphabetic character) may be obtained using similar formulas as described above. Then, magnitude and phase prediction may be performed separately using (r₁, r₂) and (Phi₁, Phi₂), respectively. More specifically, the predicted value of magnitude part at time T3 where T3>T2 may be computed as follows.

$$r 1 + \frac{( T 3 - T 1 )}{( T 2 - T 1 )} \times ( r 2 - r 1 ) . \qquad ( Math . 46 )$$

Similarly, the predicted value of phase part at time T3 where T3>T2 may be computed as

$${ϕ}_{1} + \frac{( T 3 - T 1 )}{( T 2 - T 1 )} \times ( {ϕ}_{2} - {ϕ}_{1} ) . \qquad ( Math . 47 )$$

In some exemplary embodiments where the prediction of eigenvectors or singular vectors are performed in the magnitude and phase format as discussed above, a constraint may be imposed to set the predicted magnitude is always non-negative.

In some exemplary embodiments, for instance in embodiments where domain-transformation is employed, the prediction or extrapolation may be preferred in the magnitude-phase format as described above. More specifically, if the elements of an eigenvector are complex numbers, then the real part and imaginary part of the complex number can be used to compute the magnitude and phase values. Then the magnitude and phase may be used for extrapolation, instead of the real and imaginary parts of the complex number. Here, ‘domain-transformation’ may imply transforming from a first domain to a second domain, for example, from antenna domain to beamspace domain, or from frequency (subcarrier) domain to delay domain, or from time domain to Doppler domain etc. By doing extrapolation in magnitude-phase format, a better performance (for example, better throughput) may be observed in some cases where domain-transformation is used.

In some embodiments, the predicted eigenvector may be optimized to reduce prediction error or for better performance. For example, a predicted eigenvector may be optimized to ensure that it has a unit norm. A normalization operation may be done on the predicted eigenvector to make its norm equal to one.

In some exemplary embodiment, a method may be employed to continuously track the time-variation of a same element of a same eigen vector over successive channel estimation instants. More specifically, for accurate prediction of an element of an eigen vector corresponding to a same eigenvalue, it may be necessary that the sorting order (largest to smallest eigenvalue in the S matrix obtained from EVD operation) does not affect the element which is being tracked. For example, consider a case where the time-variation of an element of the eigenvector corresponding to the largest eigenvalue is being tracked and predicted. A problem may happen if the eigenvalue which is being tracked is no longer the largest eigenvalue anymore at some instant of channel estimation. Such change in order of the eigenvalues may result in tracking a different eigenvalue. As a solution to this problem, it may be necessary that even if the order of the eigenvalues changes from a previous time instant of channel estimation to a later time instant, a method is employed to still continue tracking the same eigenvalue consistently.

In some exemplary embodiments, a method may be employed to ensure that eigenvectors are computed by a consistent method at all instances of EVD (or SVD) operation. Since eigenvectors are generally non-unique, hence any vector satisfying the properties of an eigenvector may qualify to become a valid eigenvector. For example, a scalar multiple of an eigenvector may also qualify as a valid eigenvector. Hence, for accurate prediction, it is important that the eigenvectors are computed using a consistent method and formula. Specifically, if there is a scalar multiplication happening to an eigenvector at some instances of EVD operation, then such effect must be reversed before using it for prediction operation.

In some exemplary embodiments, the prediction operation may be skipped for eigen vectors (or singular vectors) that correspond to very small eigenvalues (or singular values). More specifically, if an eigenvalue (or singular value) is less than a predetermined threshold, then the prediction operation may not be performed.

### 2.7) Prediction in Antenna-Subcarrier Domain

Assuming a multicarrier communication system, like orthogonal frequency division multiplexing where a high-rate broadband channel is divided into a plurality of low-rate subchannels (or, subcarriers). Then the BS device 100 may be able to compute frequency response of the channel from the received SRS at each of its antennas.

More specifically, the amplitude and phase of the channel corresponding to each subcarrier may be computed at each of the antennas of the BS device 100 in a method of channel estimation. The estimated channel response may then be used to obtain at least one eigenvector or singular vector. An EVD or SVD operation may be used for this purpose, although other approaches are not excluded. By obtaining the eigenvectors or singular vectors at two or more time instants, it may be possible to predict the value of eigenvectors or singular vectors at a time instant where no channel estimation is performed. More specifically, a method, including but not limited to, linear extrapolation, non-linear extrapolation, curve fitting, linear regression, non-linear regression, machine-learning-based techniques may be employed for the prediction operation. The predicted value of eigenvectors or singular vectors may be used for the purpose of downlink beamforming.

### 2.8) Prediction in Transformed Domain

In a multipath propagation environment, the multipath components may be separated based on the differences in their delays (as illustrated in FIG. 9) or angles (as illustrated in FIG. 8), or in their Doppler frequencies (as illustrated in FIG. 10). More specifically, FIG. 9 shows the multipaths 570 to 574 with different delays. Similarly, FIG. 8 shows the multipaths 550 to 554 with different angles.

In some exemplary embodiments, the BS device 100 may first perform channel estimation to obtain an estimated channel response matrix in the antenna-frequency domains at at least two different time-slots, for example at time-slot 0 and 40 as shown in FIG. 7. Then the estimated channel response matrices may be subjected to one or more first transformation operations to convert to another domain. As an example of the transformation operation, an inverse discrete Fourier transform (IDFT) may be performed along the frequency subcarrier indices to convert the estimated channel response matrices to antenna-delay domain. Another first transformation operation of the transformed channel response matrices in antenna-delay domain by using a discrete Fourier transform (DFT) along the antenna indices may result in the estimated channel response matrices in angle-delay domain (also equivalently called as beamspace-delay domain). Then, eigenvector matrices or singular vector matrices may be obtained from the transformed channel response matrices in the beamspace-delay domain, for example by using an EVD, SVD, or some equivalent operation. Two or more such eigenvector or singular vector matrices thus obtained in the transformed domain from two or more channel response matrices in the transformed domain at two different instants of time (for e.g., at time-slot 0 and 40 as shown in FIG. 7) may be used to predict another eigenvector or singular vector in the transformed domain (i.e., in the beamspace-delay domain in this example). The predicted values of the eigenvectors or singular vectors may then be subjected to one or more second transformation operations to obtain the values in antenna-frequency domain. In this particular example, the second transformation could be an IDFT along the angle indices to obtain the predicted eigenvector or singular vector matrices in antenna-delay domain. Another second transformation could be a DFT along the delay tap indices to obtain the predicted eigenvectors or singular vectors in antenna-frequency domain.

Not limited to the prediction of eigenvectors or singular vectors in beamspace-delay domain, the transformed domain in which the prediction is performed could be some combination of delay, beamspace, and Doppler domains. For example, the prediction of eigenvector matrix or singular vector matrix could be performed in a delay-beamspace-Doppler domain. Then the predicted values may be transformed back to the antenna-frequency domain. The transformation from time domain to Doppler domain may be achieved by using a DFT over time-slot indices. Similarly, to transform back from Doppler domain to time domain may be achieved by using an IDFT over Doppler tap indices.

In some embodiments, the BS device 100 may first perform channel estimation to obtain an estimated channel response matrix in the antenna-frequency domains at at least two different time-slots, for example at time-slot 0 and 40 as shown in FIG. 7. Then, a first eigenvector matrix or singular vector matrix may be obtained from the estimated channel response matrix in the antenna-frequency domains at at least two different time-slots, for example at time-slot 0 and 40. An operation like EVD, or SVD, or some equivalent method may be used to obtain the first eigenvector matrix or singular vector matrix at two different time-slots. In some embodiments, the eigenvectors or singular vectors may be obtained by some other method to reduce complexity. The at least two first eigenvector matrix or singular vector matrix obtained in the antenna-frequency domain may be subjected to one or more first transformation operations to convert to another domain. As an example of the transformation operation, an inverse discrete Fourier transform (IDFT) may be performed along the frequency subcarrier indices to convert the eigenvector matrix or singular vector matrix to antenna-delay domain. Another first transformation operation of the transformed eigenvector matrix or singular vector matrix in antenna-delay domain by using a discrete Fourier transform (DFT) along the antenna indices may result in the eigenvector matrix or singular vector matrix in angle-delay domain (also equivalently called as beamspace-delay domain). Then, two or more such eigenvector matrices or singular vector matrices obtained in the transformed domain (beamspace-delay domain in this example) at two different instants of time (for e.g., at time-slot 0 and 40 as shown in FIG. 7) may be used to predict another eigenvector matrix or singular vector matrix in the transformed domain (i.e., in the beamspace-delay domain in this example). The predicted values of the eigenvector matrix or singular vector matrix may then be subjected to one or more second transformation operations to obtain the values in antenna-frequency domain. In this particular example, the second transformation could be an IDFT along the angle indices to obtain the predicted eigenvector matrix or singular vector matrix in antenna-delay domain. Another second transformation could be a DFT along the delay tap indices to obtain the predicted eigenvector matrix or singular vector matrix from antenna-delay domain to antenna-frequency domain. The obtained predicted eigenvector matrix or singular vector matrix in antenna-frequency domain may then be used for beamformed signal transmission.

In another exemplary embodiment of the present invention, a controller may be used to decide an optimal prediction method. For example, a metric may be computed to find the difference between a predicted eigenvector and an actual eigenvector at a time-slot where channel estimation is performed. Such metric may include but not limited to a mean square error. The actual eigenvector may be obtained from an estimated channel response matrix at the time-slot of channel estimation. Based on the value of the metric, a prediction method may be selected by the controller such that the metric is optimized (for example, mean square error is minimized). Furthermore, if the value of the metric exceeds a predetermined threshold, the controller may decide not to perform any prediction.

Application software in accordance with the present disclosure, such as computer programs executed by the device and may be stored on one or more computer readable mediums. It is also contemplated that the steps identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

### 3. SUPPLEMENTAL REMARKS

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine-type communication applications.

TABLE 1

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

It should also be understood that embodiments of the present disclosure should not be limited to these embodiments but that numerous modifications and variations may be made by one of ordinary skill in the art in accordance with the principles of the present disclosure and be included within the spirit and scope of the present-disclosure as hereinafter claimed.

### 4. SUPPLEMENTARY NOTES

The whole or part of the exemplary embodiments disclosed above can be described as, but not limited to, the following supplementary notes.

### (Supplementary Note 1)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b) obtain at least two first eigenvectors or singular vectors of the channel response matrices; and
c) predict at least one second eigenvector or singular vector based on the at least two first eigenvectors or singular vectors by a predetermined prediction method, wherein the at least one second eigenvector or singular vector is used to perform signal transmission to the another communication device at a time instant where no channel estimation is performed.

### (Supplementary Note 2)

The communication device according to supplementary note 1, wherein
in the a), the at least two channel response matrices are estimated based on a reference signal received from the another communication device at predetermined intervals,
in the c), the second eigenvector or singular vector is used until a next channel response matrix is estimated.

### (Supplementary Note 3)

The communication device according to supplementary note 1 or 2 wherein in the c), prediction is performed using real and imaginary parts of the at least two first eigenvectors or singular vectors when the prediction is done in a same domain as estimation of the a); and
the prediction is performed using magnitude and phase of the at least two first eigenvectors or singular vectors when the prediction is done in a different domain than estimation of the a).

### (Supplementary Note 4)

The communication device according to supplementary note 1 or 2, wherein the c) is performed when an eigenvalue or singular value corresponding to the at least one first eigenvector or singular vector is greater than a predetermined threshold.

### (Supplementary Note 5)

The communication device according to any one of supplementary notes 1-4, wherein the c) is performed on a same element of the at least two first eigen vectors or singular vectors in all time-slots where prediction is performed.

### (Supplementary Note 6)

The communication device according to any one of supplementary notes 1-5, wherein in the b), the at least two first eigen vectors or singular vectors are obtained by a same and consistent method.

### (Supplementary Note 7)

The communication device according to any one of supplementary notes 1-6, wherein the predetermined prediction method is at least one of a linear extrapolation, a non-linear extrapolation, or a machine-learning based time-series prediction.

### (Supplementary Note 8)

The communication device according to any one of supplementary notes 1-7, wherein the at least two first channel response matrices are an estimate of the channel impulse response or channel frequency response.

### (Supplementary Note 9)

The communication device according to any one of supplementary notes 1-8, wherein in the b) and c), at least one of a precoding matrix and a beamforming weight of the wireless transceiver is computed based on the at least two first eigen vectors or singular vectors and the at least one second eigenvector or singular vector for the signal transmission.

### (Supplementary Note 10)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b.1) transform the at least two channel response matrices by at least one first transformation from antenna-frequency domain to beamspace-delay domain, to generate at least two intermediate channel response matrices;
b.2) obtain at least two first intermediate eigen vectors or singular vectors of the at least two intermediate channel response matrices;
c.1) predict at least one second intermediate eigen vector or singular vector by the predetermined prediction method using the at least two first intermediate eigen vectors or singular vectors; and
c.2) transform the at least one second intermediate eigen vectors or singular vector by at least one second transformation from the beamspace-delay domain to antenna-frequency domain, to generate the at least one second eigenvector or singular vector.

### (Supplementary Note 11)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b.1) obtain at least two eigenvectors or singular vectors of the at least two channel response matrices;
b.2) transform the at least two eigenvectors or singular vectors by at least one first transformation from antenna-frequency domain to beamspace-delay domain, to generate at least two first intermediate eigenvectors or singular vectors in beamspace-delay domain;
c.1) predict at least one second intermediate eigenvector or singular vector by a predetermined prediction method using the at least two first intermediate eigenvectors or singular vectors; and
c.2) transform the at least one second intermediate eigen vector or singular vector by at least one second transformation from the beamspace-delay domain to antenna-frequency domain, to generate the at least one second eigenvector or singular-vector.

### (Supplementary Note 12)

The communication device according to supplementary note 10 or 11, wherein the at least one first transformation is at least one of a discrete Fourier transform and an inverse discrete Fourier transform, and the at least one second transformation is at least one of a discrete Fourier transform and an inverse discrete Fourier transform.

### (Supplementary Note 13)

The communication device according to any one of supplementary notes 10-12, wherein the b.1) and b.2) are performed only at a time slot where the a) is performed, while the c.1) and c.2) are performed at every time-slot where prediction of the at least one second eigenvector or singular vector is performed.

### (Supplementary Note 14)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b.1) transform the at least two channel response matrices by at least one first transformation to generate at least two first intermediate channel response matrices;
b.2) obtain at least two first intermediate eigen vectors or singular vectors of the at least two intermediate channel response matrices;
c.1) predict at least one second intermediate eigen vectors or singular vector by the predetermined prediction method using the at least two first intermediate eigen vectors or singular vectors; and
c.2) transform the at least one second intermediate eigen vector or singular vector by at least one second transformation, to generate the at least one second eigenvector or singular vector,
wherein in the b.1), the at least one first transformation performs at least one of transformations:
b.1.1) from frequency domain to delay domain;
b.1.2) from antenna domain to angle or beamspace domain; and
b.1.3) from time domain to Doppler domain, wherein in the c.2), the at least one second transformation performs at least one of transformations:
c.2.1) from Doppler domain to time domain;
c.2.2) from angle domain or beamspace domain to antenna domain; and
c.2.3) from delay domain to frequency domain,
wherein the at least one second transformation performs an inverse transformation of the at least one first transformation.

### (Supplementary Note 15)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b.1) obtain at least two eigenvectors or singular vectors of the at least two channel response matrices;
b.2) transform the at least two eigenvectors or singular vectors by at least one first transformation to generate at least two first intermediate eigenvectors or singular vectors;
c.1) predict at least one second intermediate eigenvector or singular vector by a predetermined prediction method using the at least two first intermediate eigenvectors or singular vectors; and
c.2) transform the at least one second intermediate eigen vector or singular vector by at least one second transformation to generate the at least one second eigenvector or singular vector, wherein in the b.2), the at least one first transformation performs at least one of transformations:
b.2.1) from frequency domain to delay domain;
b.2.2) from antenna domain to angle or beamspace domain; and
b.2.3) from time domain to Doppler domain, wherein in the c.2), the at least one second transformation performs at least one of transformations:
c.2.1) from Doppler domain to time domain;
c.2.2) from angle domain or beamspace domain to antenna domain; and
c.2.3) from delay domain to frequency domain, wherein the at least one second transformation performs an inverse transformation of the at least one first transformation.

### (Supplementary Note 16)

The communication device according to supplementary note 14 or 15, wherein the at least one of the c.1) and c.2) is performed till the a) become possible.

### (Supplementary Note 17)

The communication device according to any one of supplementary notes 10-16, wherein in the c.1),
1) prediction is performed using the real and imaginary parts of the at least two first intermediate eigenvectors or singular vectors when none of the first transformation and second transformation are used, and
2) the prediction is performed using the magnitude and phase of the at least two first intermediate eigenvectors or singular vectors when at least one of the first transformation and second transformation are used.

### (Supplementary Note 18)

The communication device according to any one of supplementary notes 1-9, wherein the second eigenvector or singular vector is optimized to reduce error in prediction.

### (Supplementary Note 19)

The communication device according to supplementary note 18 wherein the second eigenvector or singular vector is normalized to have unit norm.

### (Supplementary Note 20)

The communication device according to any one of supplementary notes 10-16, wherein the second intermediate eigenvector or singular vector is optimized to reduce error in prediction.

### (Supplementary Note 21)

The communication device according to supplementary note 20 wherein the second intermediate eigenvector or singular vector is normalized to have unit norm.

### (Supplementary Note 22)

A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b) obtaining at least two first eigenvectors or singular vectors from the at least two channel response matrices; and
c) predicting at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

### (Supplementary Note 23)

The channel prediction method according to supplementary note 22, wherein
in the a), the at least two channel response matrices are estimated based on a reference signal received from the another communication device at predetermined intervals,
in the c), the second eigenvector or singular vector is used until a next channel response matrix is estimated.

### (Supplementary Note 24)

The channel prediction method according to supplementary note 22 or 23, wherein the predetermined prediction method is at least one of a linear extrapolation, a non-linear extrapolation, or a machine-learning based time-series prediction.

### (Supplementary Note 25)

The channel prediction method according to any one of supplementary notes 22-24, wherein the at least two first channel response matrices are an estimate of the channel impulse response or channel frequency response.

### (Supplementary Note 26)

The channel prediction method according to any one of supplementary notes 22-25, wherein in the b) and c), at least one of a precoding matrix and a beamforming weight of the wireless transceiver is computed based on the at least two first eigen vectors or singular vectors and the at least one second eigenvector or singular vector for the signal transmission.

### (Supplementary Note 27)

A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b.1) transforming the at least two channel response matrices by at least one first transformation from antenna-frequency domain to beamspace-delay domain, to generate at least two intermediate channel response matrices;
b.2) obtaining at least two first intermediate eigen vectors or singular vectors of the at least two intermediate channel response matrices;
c.1) predicting at least one second intermediate eigen vectors or singular vector by the predetermined prediction method using the at least two first intermediate eigen vectors or singular vectors; and
c.2) transforming the at least one second intermediate eigen vectors or singular vector by at least one second transformation from the beamspace-delay domain to antenna-frequency domain, to generate the at least one second eigenvector or singular vector.

### (Supplementary Note 28)

A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b.1) obtaining at least two eigenvectors or singular vectors of the at least two channel response matrices;
b.2) transforming the at least two eigenvectors or singular vectors by at least one first transformation from antenna-frequency domain to beamspace-delay domain, to generate at least two first intermediate eigenvectors or singular vectors in beamspace-delay domain;
c.1) predicting at least one second intermediate eigenvector or singular vector by a predetermined prediction method using the at least two first intermediate eigenvectors or singular vectors; and
c.2) transforming the at least one second intermediate eigen vector or singular vector by at least one second transformation from the beamspace-delay domain to antenna-frequency domain, to generate the at least one second eigenvector or singular vector.

### (Supplementary Note 29)

The channel prediction method according to supplementary note 27 or 28, wherein the at least one first transformation is at least one of a discrete Fourier transform and an inverse discrete Fourier transform, and the at least one second transformation is at least one of a discrete Fourier transform and an inverse discrete Fourier transform.

### (Supplementary Note 30)

The channel prediction method according to supplementary note 27 or 28, wherein the b.1) and b.2) are performed only at a time slot where the a) is performed, while the c.1) and c.2) are performed at every time-slot where prediction of the at least one second eigenvector or singular vector is performed.

### (Supplementary Note 31)

A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b.1) transforming the at least two channel response matrices by at least one first transformation to generate at least two first intermediate channel response matrices;
b.2) obtaining at least two first intermediate eigen vectors or singular vectors of the at least two intermediate channel response matrices;
c.1) predicting at least one second intermediate eigen vectors or singular vector by the predetermined prediction method using the at least two first intermediate eigen vectors or singular vectors; and
c.2) transforming the at least one second intermediate eigen vectors or singular vector by at least one second transformation, to generate the at least one second eigenvector or singular vector wherein in the b.1), the at least one first transformation performs at least one of transformations:
b.1.1) from frequency domain to delay domain;
b.1.2) from antenna domain to angle or beamspace domain; and
b.1.3) from time domain to Doppler domain,
wherein in the c.2), the at least one second transformation performs at least one of transformations:
c.2.1) from Doppler domain to time domain;
c.2.2) from angle domain to antenna domain; and
c.2.3) from delay domain to frequency domain,
wherein the at least one second transformation performs an inverse transformation of the at least one first transformation.

### (Supplementary Note 32)

A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b.1) obtaining at least two eigenvectors or singular vectors of the at least two channel response matrices;
b.2) transforming the at least two eigenvectors or singular vectors by at least one first transformation to generate at least two first intermediate eigenvectors or singular vectors;
c.1) predicting at least one second intermediate eigenvector or singular vector by a predetermined prediction method using the at least two first intermediate eigenvectors or singular vectors; and
c.2) transforming the at least one second intermediate eigen vector or singular vector by at least one second transformation to generate the at least one second eigenvector or singular vector,
wherein in the b.2), the at least one first transformation performs at least one of transformations:
b.2.1) from frequency domain to delay domain;
b.2.2) from antenna domain to angle or beamspace domain; and
b.2.3) from time domain to Doppler domain,
wherein in the c.2), the at least one second transformation performs at least one of transformations:
c.2.1) from Doppler domain to time domain;
c.2.2) from angle domain or beamspace domain to antenna domain; and
c.2.3) from delay domain to frequency domain, wherein the at least one second transformation performs an inverse transformation of the at least one first transformation.

### (Supplementary Note 33)

The channel prediction method according to supplementary note 31 or 32, wherein the at least one of the c.1) and c.2) is performed till the a) become possible.

### (Supplementary Note 34)

A non-transitory recording medium storing a computer-readable program for channel prediction in a communication device including a wireless transceiver that is configured to communicate with another communication device through a wireless channel, the computer-readable program comprising instructions to:
a) estimate at least two channel response matrices of the wireless channel based on a predetermined signal received from the another communication device;
b) obtain at least two first eigenvectors or singular vectors of the channel response matrices; and
c) predict at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

### (Supplementary Note 35)

A computer-readable program for channel prediction executed on at least one processor in a communication device including a wireless transceiver that is configured to communicate with another communication device through a wireless channel, the computer-readable program comprising instructions to:
a) estimate at least two channel response matrices of the wireless channel based on a predetermined signal received from the another communication device;
b) obtain at least two first eigenvectors or singular vectors of the channel response matrices; and
c) predict at least one second eigenvector or singular vector based on the at least two first eigen vectors or singular vectors by a predetermined prediction method, wherein the at least one second eigen vector or singular vector is used to perform signal transmission to the another communication device at a time instant where no channel estimation is performed.

### (Supplementary Note 36)

A communication system comprising:
at least one first radio device; and
at least one second radio device including a wireless transceiver and a controller, wherein the wireless transceiver of a second radio device is configured to communicate with a first radio device through a wireless channel,
wherein the controller is configured to:
a) estimate at least two channel response matrices between the second radio device and the first radio device using at least one reference signal received from the first radio device,
b) obtain at least two first eigenvectors or singular vectors of the at least two channel response matrices; and
c) predict at least one second eigenvector or singular vector based on the at least two first eigen vectors or singular vectors by a predetermined prediction method, wherein the at least one second eigen vector or singular vector is used to perform signal transmission to the first radio device at a time instant where no channel estimation is performed.

### (Supplementary Note 37)

A communication system comprising:
at least one first radio device; and
at least one second radio device including a wireless transceiver and a controller, wherein the wireless transceiver of a second radio device is configured to communicate with a first radio device through a wireless channel,
wherein the controller is configured to:
a) estimate at least two channel response matrices between the second radio device and the first radio device using at least one reference signal received from the first radio device;
b.1) transform the at least two channel response matrices from an antenna-frequency domain to another domain using at least one first transformation, to generate at least two intermediate channel response matrices;
b.2) obtain at least two first intermediate eigenvectors or singular vectors of the at least two intermediate channel response matrices in the another domain; and
c.1) predict at least one second intermediate eigenvector or singular vector in the another domain; and
c.2) transform the at least one second intermediate eigenvector or singular vector to the antenna-frequency domain using at least one second transformation, to generate the at least one second eigenvector or singular vector.

### (Supplementary Note 38)

A communication system comprising:
at least one first radio device; and
at least one second radio device including a wireless transceiver and a controller, wherein the wireless transceiver of a second radio device is configured to communicate with a first radio device through a wireless channel,
wherein the controller is configured to:
a) estimate at least two channel response matrices between the second radio device and the first radio device using at least one reference signal received from the first radio device;
b.1) obtain at least two eigenvectors or singular vectors of the at least two channel response matrices;
b.2) transform the at least two eigenvectors or singular vectors by at least one first transformation from antenna-frequency domain to beamspace-delay domain, to generate at least two first intermediate eigenvectors or singular vectors in beamspace-delay domain;
c.1) predict at least one second intermediate eigenvector or singular vector by a predetermined prediction method using the at least two first intermediate eigenvectors or singular vectors; and
c.2) transform the at least one second intermediate eigen vector or singular vector by at least one second transformation from the beamspace-delay domain to antenna-frequency domain, to generate the at least one second eigenvector or singular vector.

### (Supplementary Note 39)

The communication system according to supplementary note 37 or 38, wherein
the at least one first transformation includes at least one of a discrete Fourier transform and discrete inverse Fourier transform, and
the at least one second transformation includes at least one of an inverse discrete Fourier transform and a discrete Fourier transform.

### (Supplementary Note 40)

The communication system according to supplementary note 37, wherein:
in the b.1), the at least two channel response matrices are transformed by at least one of:
(b.1.1) frequency domain to delay domain;
(b.1.2) antenna domain to angle domain; and
(b.1.3) time domain to Doppler domain,
in the c.2), the at least one second intermediate eigenvector or singular vector is transformed using at least one of:
(c.2.1) Doppler domain to time domain
(c.2.2) angle domain to antenna domain
(c.2.3) delay domain to frequency domain.

### (Supplementary Note 41)

The communication system according to supplementary note 38, wherein:
in the b.2), the at least one first transformation performs at least one of transformations:
b.2.1) from frequency domain to delay domain;
b.2.2) from antenna domain to angle or beamspace domain; and
b.2.3) from time domain to Doppler domain,
wherein in the c.2), the at least one second transformation performs at least one of transformations:
c.2.1) from Doppler domain to time domain;
c.2.2) from angle domain or beamspace domain to antenna domain; and
c.2.3) from delay domain to frequency domain,
wherein the at least one second transformation performs an inverse transformation of the at least one first transformation.

### (Supplementary Note 42)

The communication device according to any one of supplementary notes 1-21, wherein in the c), the second eigenvector is sequentially predicted based on a predetermined number of first eigenvectors that have been computed most recently based on the predetermined signal received from the another communication device.

### 5. FURTHER SUPPLEMENTARY NOTES

The whole or part of the exemplary embodiments disclosed above may be described as, but not limited to, the following further supplementary notes (abbreviated as FSN).

### (FSN 1)

An apparatus comprising:
a memory that stores program including instructions for eigenvector or singular vector prediction; and
a controller that is configured to execute the instructions to:
a) estimate at least two channel response matrices of the wireless channel based on a predetermined signal received from the another communication device;
b) obtain at least two first eigenvectors of the at least two channel response matrices;
c) predict at least one second eigenvector based on the at least two first eigen vectors by a prediction method; and
d) perform signal transmission to the another communication device using the at least one second eigen vector at a time.

### (FSN 2)

The apparatus according to FSN 1, wherein
the b) comprises:
transforming the at least two channel response matrices from the antenna-frequency domain to another domain using at least one first transformation; and
obtaining the at least two first eigenvectors in the another domain; and
the c) comprises:
predicting the at least one second eigenvector in the another domain; and
transforming the at least one second eigenvector to the antenna-frequency domain using at least one second transformation.

### (FSN3)

The apparatus according to FSN 1, wherein
the b) comprises:
b.1) obtaining at least two eigenvectors of the at least two channel response matrices; and
b.2) transforming the at least two eigenvectors by at least one first transformation from antenna-frequency domain to beamspace-delay domain, to generate at least two first intermediate eigenvectors in beamspace-delay domain;
the c) comprises:
c.1) predicting at least one second intermediate eigenvector by a predetermined prediction method using the at least two first intermediate eigenvectors; and
c.2) transforming the at least one second intermediate eigen vector by at least one second transformation from the beamspace-delay domain to antenna-frequency domain, to generate the at least one second eigenvector.

### (FSN 4)

The apparatus according to FSN 2 or 3, wherein:
(a) the first transformation is at least one of a discrete Fourier transform or discrete inverse Fourier transform or some variant.
(b) the second transformation is at least one of an inverse discrete Fourier transform or a discrete Fourier transform or some variant.

### (FSN 5)

The apparatus according to FSN 2, wherein:
the at least one first transformation performs at least one of:
(b.1) frequency domain to delay domain
(b.2) antenna domain to angle domain
(b.3) time domain to Doppler domain
the at least one second transformation performs at least one of:
(c.1) Doppler domain to time domain
(c.2) angle domain to antenna domain
(c.3) delay domain to frequency domain.

### (FSN 6)

The apparatus according to FSN 3, wherein:
wherein in the b.2), the at least one first transformation performs at least one of transformations:
b.2.1) from frequency domain to delay domain;
b.2.2) from antenna domain to angle or beamspace domain; and
b.2.3) from time domain to Doppler domain,
wherein in the c.2), the at least one second transformation performs at least one of transformations:
c.2.1) from Doppler domain to time domain;
c.2.2) from angle domain or beamspace domain to antenna domain; and
c.2.3) from delay domain to frequency domain,
wherein the at least one second transformation performs an inverse transformation of the at least one first transformation.

### (FSN 7)

A communication system comprising at least one first radio device and at least one second radio device, wherein
the first radio device sends at least one reference signal to the second radio device, and
the second radio device including a controller configured to:
a) estimate at least two channel response matrices between the second radio device and the first radio device using the reference signal,
b) obtain at least two first eigenvectors of the estimated at least two channel response matrices;
c) predict at least one second eigenvector based on the at least two first eigen vectors by a prediction method; and
d) perform signal transmission to the another communication device using the at least one predicted second eigen vector at a time.

### (FSN 8)

The communication system according to FSN 7, wherein
the a) comprises transforming the at least two estimated channel response matrices from the antenna-frequency domain to another domain using at least one first transformation;
the b) comprises obtaining the at least two first eigenvectors or singular vectors in the another domain; and
the c) comprises predicting the at least one second eigenvector in the another domain and transforming the at least one second eigenvector to the antenna-frequency domain using at least one second transformation.

### (FSN 9)

The communication system according to FSN 8, wherein
(a) the first transformation is at least one of a discrete Fourier transform or discrete inverse Fourier transform or some variant.
(b) the second transformation is at least one of an inverse discrete Fourier transform or a discrete Fourier transform or some variant.

### (FSN 10)

The communication system according to FSN 8, wherein
(a) the at least two estimated channel response matrices are transformed to another domain by at least one of:
(a.1) frequency domain to delay domain
(a.2) antenna domain to angle domain
(a.3) time domain to Doppler domain
(b) the output of the prediction operation is transformed from the another domain using at least one of:
(b.1) Doppler domain to time domain
(b.2) angle domain to antenna domain
(b.3) delay domain to frequency domain.

### 6. STILL FURTHER SUPPLEMENTARY NOTES

The whole or part of the exemplary embodiments disclosed above may be described as, but not limited to, the following still further supplementary notes (abbreviated as SFSN).

### (SFSN 1)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b) obtain at least two first eigenvectors of the estimated at least two channel response matrices;
c) predict at least one second eigenvector based on the at least two first eigen vectors by a prediction method, for signal transmission to the another communication device at a time instant where no channel estimation is performed.

### (SFSN 2)

A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device in a first domain;
b) obtain at least two first eigenvectors of the estimated at least two channel response matrices in the first domain;
c) transform the at least two first eigenvectors of the estimated at least two channel response matrices from the first domain to a second domain;
d) predict at least one second eigenvector based on the at least two first eigen vectors by a prediction method in the second domain;
e) transform the predicted at least one second eigenvector from second domain to the first domain; and
f) use the predicted at least one second eigenvector in the first domain for signal transmission to the another communication device at a time instant where no channel estimation is performed.

### (SFSN 3)

A communication device comprising:
a wireless transceiver equipped with a controller configured to:
a) compute a metric to compare a predicted eigenvector and an actual eigenvector; and
b) select a prediction method based on the metric.

### (SFSN 4)

The communication device according to SFSN 3, wherein in the b), the second eigenvector is sequentially predicted based on a predetermined number of first eigenvectors that have been obtained most recently based on the predetermined signal received from the another communication device.

The above exemplary embodiments can be applied to wireless communication systems employing beamforming transmission.

### REFERENCE SIGNS LIST

100 Base station (BS) device
101 RF (Radio Frequency) front end
102 fast Fourier transform (FFT) section
103 inverse FFT (IFFT) section
TR(1)-TR(M) Wireless transceiver
104 Channel estimator
105 eigen vector predictor
106 Precoder

What is claimed is:

1. A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b) obtain at least two first eigenvectors or singular vectors of the channel response matrices; and
c) predict at least one second eigenvector or singular vector based on the at least two first eigenvectors or singular vectors by a predetermined prediction method, wherein the at least one second eigenvector or singular vector is used to perform signal transmission to the another communication device at a time instant where no channel estimation is performed.

2. The communication device according to claim 1, wherein
in the a), the at least two channel response matrices are estimated based on a reference signal received from the another communication device at predetermined intervals,
in the c), the second eigenvector or singular vector is used until a next channel response matrix is estimated.

3. The communication device according to claim 1 wherein in the c),
prediction is performed using real and imaginary parts of the at least two first eigenvectors or singular vectors when the prediction is done in a same domain as estimation of the a); and
the prediction is performed using magnitude and phase of the at least two first eigenvectors or singular vectors when the prediction is done in a different domain than estimation of the a).

4. The communication device according to claim 1, wherein the c) is performed when an eigenvalue or singular value corresponding to the at least one first eigenvector or singular vector is greater than a predetermined threshold.

5.-6. (canceled)

7. The communication device according to claim 1, wherein the predetermined prediction method is at least one of a linear extrapolation, a non-linear extrapolation, or a machine-learning based time-series prediction.

8. The communication device according to claim 1, wherein the at least two first channel response matrices are an estimate of the channel impulse response or channel frequency response.

9. The communication device according to claim 1, wherein in the b) and c), at least one of a precoding matrix and a beamforming weight of the wireless transceiver is computed based on the at least two first eigenvectors or singular vectors and the at least one second eigenvector or singular vector for the signal transmission.

10. A communication device comprising:
a wireless transceiver configured to communicate with another communication device through a wireless channel; and
at least one processor configured to execute instructions to:
a) estimate at least two channel response matrices of the wireless channel based on a predetermined signal received from the another communication device;
b.1) transform the at least two channel response matrices by at least one first transformation from antenna-frequency domain to beamspace-delay domain, to generate at least two intermediate channel response matrices;
b.2) obtain at least two first intermediate eigenvectors or singular vectors of the at least two intermediate channel response matrices;
c.1) predict at least one second intermediate eigenvectors or singular vector by the predetermined prediction method using the at least two first intermediate eigenvectors or singular vectors; and
c.2) transform the at least one second intermediate eigenvectors or singular vector by at least one second transformation from the beamspace-delay domain to antenna-frequency domain, to generate the at least one second eigenvector or singular vector.

11. The communication device according to claim 1, wherein
the b) and the c) is performed by:
b.1) obtaining at least two eigenvectors or singular vectors of the at least two channel response matrices;
b.2) transforming the at least two eigenvectors or singular vectors by at least one first transformation from antenna-frequency domain to beamspace-delay domain, to generate at least two first intermediate eigenvectors or singular vectors in beamspace-delay domain;
c.1) predicting at least one second intermediate eigenvector or singular vector by a predetermined prediction method using the at least two first intermediate eigenvectors or singular vectors; and
c.2) transforming the at least one second intermediate eigenvectors or singular vector by at least one second transformation from the beamspace-delay domain to antenna-frequency domain, to generate the at least one second eigenvector or singular vector.

12. The communication device according to claim 10, wherein the at least one first transformation is at least one of a discrete Fourier transform and an inverse discrete Fourier transform, and the at least one second transformation is at least one of a discrete Fourier transform and an inverse discrete Fourier transform.

13. The communication device according to claim 10, wherein the b.1) and b.2) are performed only at a time slot where the a) is performed, while the c.1) and c.2) are performed at every time-slot where prediction of the at least one second eigenvector or singular vector is performed.

14.-16. (canceled)

17. The communication device according to claim 10, wherein in the c.1),
1. prediction is performed using the real and imaginary parts of the at least two first intermediate eigenvectors or singular vectors when none of the first transformation and second transformation are used, and
2. the prediction is performed using the magnitude and phase of the at least two first intermediate eigenvectors or singular vectors when at least one of the first transformation and second transformation are used.

18. The communication device according to claim 1, wherein the second eigenvector or singular vector is optimized to reduce error in prediction.

19. The communication device according to claim 18 wherein the second eigenvector or singular vector is normalized to have unit norm.

20. The communication device according to claim 10, wherein the second intermediate eigenvector or singular vector is optimized to reduce error in prediction.

21. (canceled)

22. A channel prediction method by at least one processor in a communication device including a wireless transceiver, wherein the wireless transceiver is configured to communicate with another communication device through a wireless channel, the method comprising:
a) estimating at least two channel response matrices of the wireless channel based on a predetermined signal received from the another communication device;
b) obtaining at least two first eigenvectors or singular vectors from the at least two channel response matrices; and
c) predicting at least one second eigenvector or singular vector based on the at least two first eigenvectors or singular vectors by a predetermined prediction method, wherein the at least one second eigenvector or singular vector is used to perform signal transmission to the another communication device at a time instant where no channel estimation is performed.

23. The channel prediction method according to claim 22, wherein
in the a), the at least two channel response matrices are estimated based on a reference signal received from the another communication device at predetermined intervals,
in the c), the second eigenvector or singular vector is used until a next channel response matrix is estimated.

24. The channel prediction method according to claim 22, wherein the predetermined prediction method is at least one of a linear extrapolation, a non-linear extrapolation, or a machine-learning based time-series prediction.

25. (canceled)

26. The channel prediction method according to claim 22, wherein in the b) and c), at least one of a precoding matrix and a beamforming weight of the wireless transceiver is computed based on the at least two first eigenvectors or singular vectors and the at least one second eigenvector or singular vector for the signal transmission.

27.-40. (canceled)

41. The communication device according to claim 1, wherein in the c), the second eigenvector is sequentially predicted based on a predetermined number of first eigenvectors that have been computed most recently based on the predetermined signal received from the another communication device.
